(19) United States
(12) Patent Application Publication
(10) Pub. No.: US 2007/0005588 A1
(43) Pub. Date: Jan. 4, 2007

(54) Determining relevance using queries as surrogate content

(75) Inventors: Benyu Zhang, Beijing (CN); Gui-Rong Xue, Shanghai (CN); Hua-Jun Zeng, Beijing (CN); Wei-Ying Ma, Beijing (CN); Zheng Chen, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/174,438

(22) Filed: Jul. 1, 2005

(51) Int. Cl. G06F 17/30

(52) U.S. Cl. 707/5

(57) ABSTRACT

A method and system for determining the relevance of a document to a query based on surrogate content is provided. The relevance system associates queries with documents. The relevance system calculates the relevance of a document to a query based at least in part on the similarity of the associated queries to the query. When multiple queries are associated with a document, the relevance system may provide a weight for each query for calculating a combined relevance score for the associated queries.

### BACKGROUND

Many search engine services, such as Google and Overture, provide for searching for information that is accessible via the Internet. These search engine services allow users to search for display pages, such as web pages, that may be of interest to users. After a user submits a search request (i.e., a query) that includes search terms, the search engine service identifies web pages that may be related to those search terms. To quickly identify related web pages, the search engine services may maintain a mapping of keywords to web pages. This mapping may be generated by “crawling” the web (i.e., the World Wide Web) to identify the keywords of each web page. To crawl the web, a search engine service may use a list of root web pages to identify all web pages that are accessible through those root web pages. The keywords of any particular web page can be identified using various well-known information retrieval techniques, such as identifying the words of a headline, the words supplied in the metadata of the web page, the words that are highlighted, and so on. The search engine service may generate a relevance score to indicate how relevant the information of the web page may be to the search request based on the closeness of each match, web page importance or popularity (e.g., Google's PageRank), and so on. The search engine service then displays to the user links to those web pages in an order that is based on a ranking that may be determined by their relevance, popularity, or some other measure.

Three well-known techniques for ranking web pages are PageRank, HITS (“Hyperlinked-Induced Topic Search”), and DirectHIT. PageRank is based on the principle that web pages will have links to (i.e., “outgoing links”) important web pages. Thus, the importance of a web page is based on the number and importance of other web pages that link to that web page (i.e., “incoming links”). In a simple form, the links between web pages can be represented by matrix A, where Aᵢⱼ represents the number of outgoing links from web page i to web page j. The importance score wⱼ for web page j can be represented by the following equation:
wⱼ=ΣᵢAᵢⱼwᵢ

This equation can be solved by iterative calculations based on the following equation:
A^{T}w=w
where w is the vector of importance scores for the web pages and is the principal eigenvector of A^{T}.

The HITS technique is additionally based on the principle that a web page that has many links to other important web pages may itself be important. Thus, HITS divides “importance” of web pages into two related attributes: “hub” and “authority.” “Hub” is measured by the “authority” score of the web pages that a web page links to, and “authority” is measured by the “hub” score of the web pages that link to the web page. In contrast to PageRank, which calculates the importance of web pages independently from the query, HITS calculates importance based on the web pages of the result and web pages that are related to the web pages of the result by following incoming and outgoing links. HITS submits a query to a search engine service and uses the web pages of the result as the initial set of web pages. HITS adds to the set those web pages that are the destinations of incoming links and those web pages that are the sources of outgoing links of the web pages of the result. HITS then calculates the authority and hub score of each web page using an iterative algorithm. The authority and hub scores can be represented by the following equations:

$$a ( p ) = {\sum }_{q -> p} h ( q ) and h ( p ) = {\sum }_{p -> q} a ( q )$$

where a(p) represents the authority score for web page p and h(p) represents the hub score for web page p. HITS uses an adjacency matrix A to represent the links. The adjacency matrix is represented by the following equation:

$${b}_{ij} = \{ \begin{matrix}1 if page i has a link to page j , \\ 0 otherwise\end{matrix}$$

The vectors a and h correspond to the authority and hub scores, respectively, of all web pages in the set and can be represented by the following equations:
a=A^{T}h and h=Aa

Thus, a and h are eigenvectors of matrices A^{T}A and AA^{T}. HITS may also be modified to factor in the popularity of a web page as measured by the number of visits. Based on an analysis of click-through data, bᵢⱼ of the adjacency matrix can be increased whenever a user travels from web page i to web page j.

DirectHIT ranks web pages based on past user history with results of similar queries. For example, if users who submit similar queries typically first selected the third web page of the result, then this user history would be an indication that the third web page should be ranked higher. As another example, if users who submit similar queries typically spend the most time viewing the fourth web page of the result, then this user history would be an indication that the fourth web page should be ranked higher. DirectHIT derives the user histories from analysis of click-through data.

The effectiveness of a search engine service depends in large part on the accuracy of assessment of the relevance of a web page to a query. Typical techniques for assessing relevance compare the terms of a query to the content of web pages. These techniques are often not accurate, especially when queries have a small number of terms, which may be ambiguous, and when web pages contain noisy content that is not important to the overall subject matter of the web page. To help improve the accuracy, some search engine services use surrogate content, such as anchor text, as additional description of web pages. Anchor text is the description that a web page author gives for a link to another web page that is included on the authored web page. Thus, the anchor text of a link may serve as surrogate content of the linked-to web page. The accuracy of assessing relevance can be improved when the anchor text is considered in addition to the content of the web page. The accuracy depends in large part on the number of links to a web page and how fairly the anchor text describes the web page. Moreover, since the content of web pages may change over time, the accuracy also depends on how fairly the anchor text describes the changed content.

### SUMMARY

A method and system for determining the relevance of a document to a query based on surrogate content is provided. The relevance system associates queries with documents. The relevance system calculates the relevance of a document to a query based at least in part on the similarity of the associated queries to the query. When multiple queries are associated with a document, the relevance system may provide a weight for each query for calculating a combined relevance score for the associated queries. The relevance system may combine the similarity based on document content and the similarity based on the associated queries to give an overall relevance score.

The relevance system may associate queries with a document using different techniques. The relevance system may associate a query with a document when the document was selected from the result of that query. The relevance system may also associate with a document the queries of similar documents. Documents may be considered similar based on the documents being selected from the result of the same query. Documents may also be considered similar based on the interdependence of the similarity between documents and the similarity between queries.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagram that illustrates selecting queries and selected documents.

FIG. 2 is a diagram that illustrates the interdependence similarity association of selecting queries and selected documents.

FIG. 3 is a block diagram that illustrates components of the relevance system in one embodiment.

FIG. 4 is a flow diagram illustrating the processing of the score document relevance component of the relevance system in one embodiment.

FIG. 5 is a flow diagram that illustrates the processing of the generate click-through session counts component of the relevance system in one embodiment.

FIG. 6 is a flow diagram that illustrates the processing of the selecting query association component of the relevance system in one embodiment.

FIG. 7 is a flow diagram that illustrates the processing of the co-visited similarity association component of the relevance system in one embodiment.

FIG. 8 is a flow diagram that illustrates the processing of the calculate visits component of the relevance system in one embodiment.

FIG. 9 is a flow diagram that illustrates the processing of the calculate co-visited similarity component of the relevance system in one embodiment.

FIG. 10 is a flow diagram that illustrates the processing of the associate queries with documents component of the relevance system in one embodiment.

FIG. 11 is a flow diagram that illustrates the processing of the interdependence similarity association component of the relevance system in one embodiment.

FIG. 12 is a flow diagram that illustrates the processing of the calculate interdependence similarity component of the relevance system in one embodiment.

FIG. 13 is a flow diagram that illustrates the processing of the calculate query similarity component of the relevance system in one embodiment.

FIG. 14 is a flow diagram that illustrates the processing of the calculate document similarity component of the relevance system in one embodiment.

### DETAILED DESCRIPTION

A method and system for determining the relevance of a document to a query based on surrogate content is provided. In one embodiment, the relevance system associates queries, which may be referred to as a type of “surrogate content,” with documents. For example, the relevance system may analyze click-through data to identify queries, referred to as “selecting queries,” from which a user selected a web page, referred to as a “selected web page,” from the results of the queries. The relevance system calculates the relevance of a document to a query based at least in part on the similarity of the associated queries to the query. For example, the relevance system may calculate the relevance of a web page to a query by calculating the similarity between the associated selecting queries and the query. When multiple queries are associated with a document, the relevance system may provide a weight for each query for calculating a combined relevance score for the associated queries. In this way, the relevance system allows surrogate content derived from queries to be used in calculating the relevance of a document to a query.

In one embodiment, the relevance system associates a selecting query with a document when that document is similar to a selected document of the selecting query. Many different techniques may be used to calculate the similarity between documents. For example, the similarity between documents may be calculated using a term frequency by inverse document frequency (“TF*IDF”) metric. As another example, the similarity between documents may be based on whether the documents have been “co-visited.” Two documents are co-visited when the documents are selected from the same query. When a user submits a query and then selects document A and document B from the query result, document A is considered similar to document B. Because the documents are similar, other selecting queries for document A can be associated with document B, and other selecting queries for document B can be associated with document A.

In one embodiment, the relevance system calculates the similarity between documents based on the interdependence of the similarity between documents and the similarity between queries. The interdependence of the similarities means that documents are more similar when their selecting queries are more similar and that queries are more similar when their selected documents are more similar. The relevance system uses a recursive definition of these similarities and iteratively calculates the similarity.

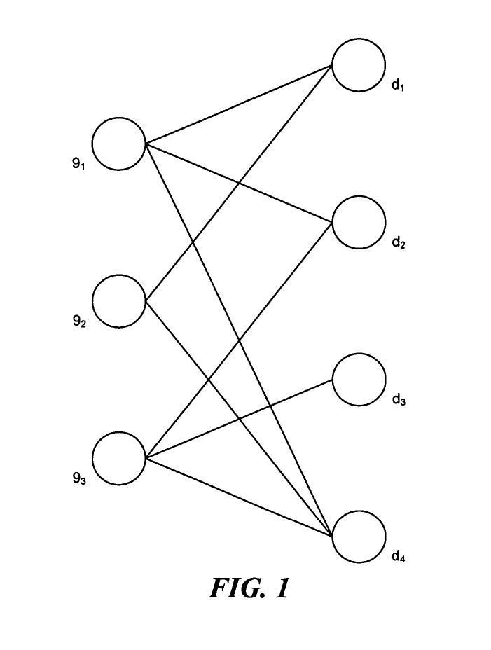

FIG. 1 is a diagram that illustrates selecting queries and selected documents. The queries q₁, q₂, and q₃ are connected to one or more of the documents d₁, d₂, d₃, and d₄. The line connecting a query and a document indicates that the document was a selected by a user from the result of that query. For example, since q₁ is connected to d₁, d₂, and d₄, then a user selected each of those documents from the result of q₁. A user, however, did not select d₃ from the result of q₁, possibly because d₃ was not in the result of q₁. The relevance system analyzes click-through data and generates query and document pairs indicating that the query is a selecting query for that document. The relevance system also generates a count for each line indicating the number of query sessions in which the query was a selecting query of the document. A query session is from when a user submits a query to when the user stops selecting documents of the query result. Since the count is of query sessions, rather than selecting of documents, the relevance system will only increase the count of a query and document pair by 1 even though a user selects that document multiple times from the same query result. The relevance system then associates queries with documents when queries are paired with a document and/or when queries are selecting queries for similar documents.

In one embodiment, the relevance system associates only selecting queries with their selected documents, which is referred to as “selecting query association.” When multiple queries are associated with a document, the relevance system calculates a weight for each query. The relevance system uses that weight when calculating the overall similarity of the associated queries to a query. The relevance system may calculate the weight of each query using the following equation:
Wᵢⱼ=Cᵢⱼ
where Wᵢⱼ is the weight for qⱼ associated with dᵢ and Cᵢⱼ is the count for qⱼ for dᵢ. The selecting query association may achieve good performance if the query click-through data is complete so that each query can be associated with all the documents with which it should be associated and with the appropriate weight. But, in typical click-through data, the selecting queries of a document represent only a small portion of the queries that should be associated with a document. This data incompleteness problem may result in the performance of the selecting query association dropping significantly.

In one embodiment, the relevance system uses a “co-visited similarity association” to associate selecting queries of co-visited documents with each other. Two documents are “co-visited” when those documents are selected during the same query session. The relevance system calculates the similarity between pairs of documents based on the ratio of the number of query sessions during which both documents were selected to the number of query sessions in which only one of the documents was selected. The similarity of documents is represented by the following equation:

$$S ( {d}_{i} , {d}_{j} ) = \frac{visited ( {d}_{i} , {d}_{j} )}{visited ( {d}_{i} ) + visited ( {d}_{j} ) - visited ( {d}_{i} , {d}_{j} )} \qquad ( 2 )$$

where S(dᵢ,dⱼ) is the similarity of dᵢ to dⱼ, visited (dᵢ,dⱼ) is the number of query sessions in which dᵢ and dⱼ were co-visited, and visited (dᵢ) and visited (dⱼ) are the number of sessions in which dᵢ and dⱼ were visited (i.e., selected). A value of 0 means that dᵢ and dⱼ were never co-visited in a query session and a value of 1 means that dᵢ and dⱼ were always co-visited in a session. Referring to FIG. 1, if the count of each line is 1, then the similarity between d₂ and d₃ is calculated by the following equation:

$$S ( {d}_{2} , {d}_{3} ) = \frac{1}{2 + 1 - 1} = 0.5$$

and the similarity between d₃ and d₄ is calculated by the following equation:

$$S ( {d}_{3} , {d}_{4} ) = \frac{1}{1 + 3 - 1} = 0.33$$

If the similarity value between two documents is greater than a minimum threshold σ, then the relevance system treats those two documents as similar. For example, if σ is equal to 0.4, then d₂ and d₃ are similar to each other, and d₃ and d₄ are dissimilar. Furthermore, if σ is set to 1, which means that two documents have the same set of selecting queries, then the co-visited similarity association is the same as the selecting query association. If σ is set to 0, then the co-visited similarity association means that any two documents are similar if they are in the same query result. In one embodiment, the relevance system sets σ to 0.3 because experiments indicate that the precision of queries associated with a given document tends to be highest.

The relevance system factors in the similarity between documents when calculating the weight of the queries associated with a document. In particular, the weight of a query increases as its similarity increases. The relevance system calculates the weight factoring in similarity as represented by the following equation:

$${W}_{ij} = {\sum }_{k ∈ Sim ( {d}_{i} )} S ( {d}_{i} , {d}_{k} ) \times {C}_{kj} \qquad ( 3 )$$

where Wᵢⱼ represents the weight of qⱼ to dᵢ, Sim(dᵢ) is the set of all documents similar to dᵢ, and Cₖⱼ is the count of qⱼ for dₖ.

The co-visited similarity association only considers similarity of documents but does not factor in the similarity of queries. As a result, the similarity of any two documents is not as accurate as it could be. Another difficulty is that data for the co-visited relationships between a query and web pages is sparse because the average number of queries to a document is typically only 1.5. To help overcome the sparseness of the data and improve the accuracy, the relevance system calculates a similarity using an “interdependence similarity association.” The relevance system implements the interdependence similarity association using an iterative algorithm in which the similarity flows from similar queries to the selected documents and from similar documents to selecting queries. The relevance system assigns a similarity score of 1 to an object (i.e., a document for a query) and itself as representing maximally similar objects.

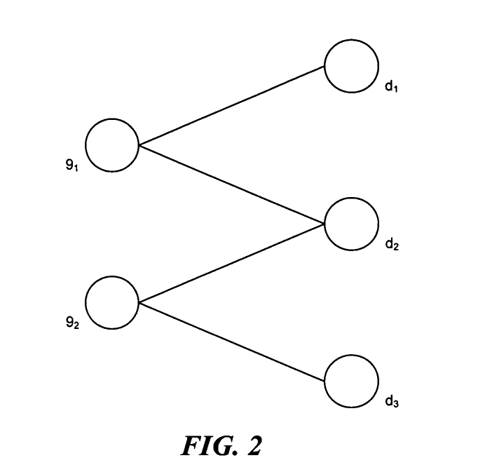

FIG. 2 is a diagram that illustrates the interdependence similarity association of selecting queries and selected documents. Since q₁ and q₂ are connected to the same document d₂, they are similar. Since d₁ and d₂ are connected to this same query q₁, they are similar. Since d₁ and d₃ are not connected to the same query, they are not similar by reason of being connected to the same query. However, the similarity between d₁ and d₃ can be propagated because q₁ and q₂ are similar. The relevance system represents the similarity between qₛ and qₜ by S_{Q}[qₛ,qₜ]∈[0,1] and the similarity between dₛ and dₜ by S_{D}[dₛ, dₜ] ∈[0,1]. The relevance system represents the similarity of queries by the following equation:

$${S}_{Q} [ {q}_{s} , {q}_{t} ] = \frac{C}{\vert O ( {q}_{s} ) \vert \vert O ( {q}_{t} ) \vert} {\sum }_{i = 1}^{\vert O ( {q}_{s} ) \vert} {\sum }_{j = 1}^{\vert O ( {q}_{t} ) \vert} {S}_{D} [ {O}^{i} ( {q}_{s} ) , {O}^{j} ( {q}_{t} ) ] \qquad ( 4 )$$

where C is a decay factor, O(q) is the set of the selected documents of q, and Oⁱ(q) represents the ith document in the set. The relevance system represents a similarity of documents by the following equation:

$${S}_{D} [ {d}_{s} , {d}_{t} ] = \frac{C}{\vert I ( {d}_{s} ) \vert \vert I ( {d}_{t} ) \vert} {\sum }_{i = 1}^{\vert I ( {d}_{s} ) \vert} {\sum }_{j = 1}^{\vert I ( {d}_{t} ) \vert} {S}_{Q} [ {I}^{i} ( {d}_{s} ) , {I}^{j} ( {d}_{t} ) ] \qquad ( 5 )$$

where C is a decay factor (e.g., 0.7), I(d) is the set of the selecting queries of d, and Iⁱ(d) represents the ith query in the set. The relevance system iteratively calculates the values of these recursive equations until they converge. The relevance system initializes the similarity of documents as represented by the following equation:

$${S}^{0} ( {d}_{s} , {d}_{t} ) = \{ \begin{matrix}0 & ( {d}_{s} \neq {d}_{t} ) \\ 1 & ( {d}_{s} = {d}_{t} )\end{matrix} \qquad ( 6 )$$

where S⁰ is the initial similarity between dₛ and dₜ.

After the interdependence similarity between documents is calculated, the relevance system associates with a document the selecting queries of another document whose similarity is above a similarity threshold δ. The relevance system then calculates the weight for the queries associated with each document in a manner analogous to that of the co-visited similarity association. When new documents are added to a collection (e.g., new web pages come online), the relevance system using the interdependence similarity association may be able to quickly associate many queries with the new documents based on only a few selecting queries of that document. Thus, when a new document is only selected by q₁, which is a selecting query to many existing documents d₁, d₂, . . . , dₖ, the new document can be associated with all the selecting queries of those existing documents. In contrast, the co-visited similarity association would require at least one query session in which the document and another document were co-visited and may require many such sessions to achieve an acceptable accuracy in the relevancy determination.

The relevance system may use various techniques to calculate relevance of a query to a document based on the document content and the surrogate content. A data fusion technique combines the document content and the surrogate content to generate a virtual content. The data fusion technique then indexes and processes the virtual content using conventional techniques. A result fusion technique keeps the document content and surrogate content separate. The result fusion technique indexes and processes the document content and surrogate content separately using conventional techniques. The conventional techniques generate a relevance score for the document content and the surrogate content. The relevance system that combines the similarity scores as represented by the following equation
Score=α×SimDocument+(1−α)×SimSurrogate (α∈[0,1]) (7)
where SimDocument is the content-based similarity between the document content and a query and SimSurrogate is the content-based similarity between the surrogate content and a query.

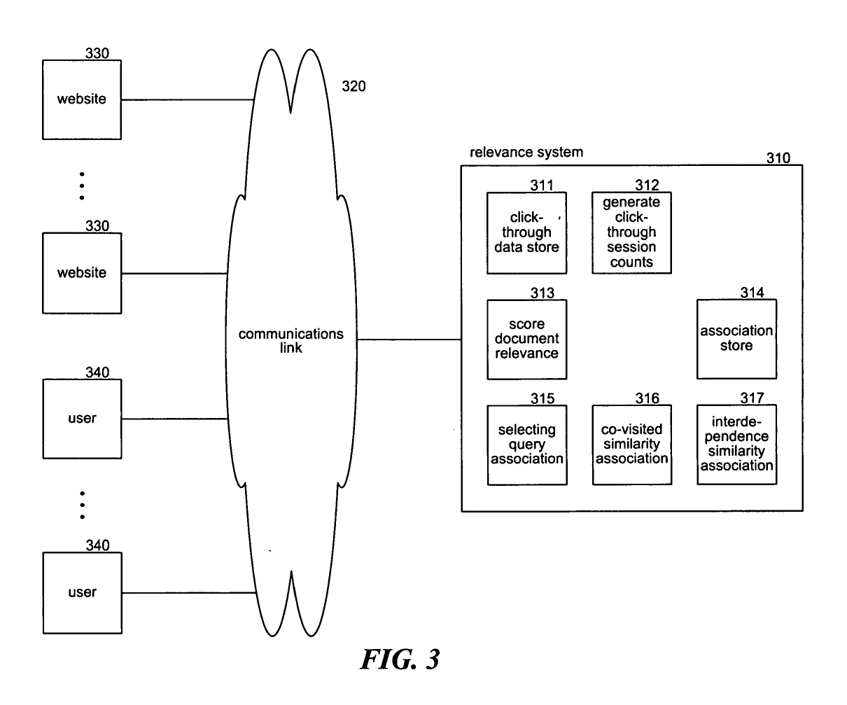

FIG. 3 is a block diagram that illustrates components of the relevance system in one embodiment. The relevance system 310 is connected to web sites 330 and user computers 340 via communications link 320. The relevance system gathers click-through data from web sites and associates queries with web pages as surrogate content. The relevance system then calculates the relevance of web pages to a query submitted via a user computer. The relevance system includes a click-through data store 311, a generate click-through session counts component 312, a score document relevance component 313, an association store 314, a selecting query association component 315, a co-visited similarity association component 316, and an interdependence similarity association component 317. The click-through data store contains the data collected from the various web sites. The generate click-through session counts component analyzes the click-through data to identify selecting queries and their selected web pages and to count the number of sessions in which each document of each query and document pair is selected. The selecting query association component, the co-visited similarity association component, and the interdependence similarity association component each provide a different embodiment for associating queries with web pages as described above. These components generate the association of queries with web pages and store an indication of the association in the association store. The score document relevance component calculates the relevance of a document to a query using the queries associated with the documents as indicated by the association store.

The computing device on which the relevance system is implemented may include a central processing unit, memory, input devices (e.g., keyboard and pointing devices), output devices (e.g., display devices), and storage devices (e.g., disk drives). The memory and storage devices are computer-readable media that may contain instructions that implement the relevance system. In addition, the data structures and message structures may be stored or transmitted via a data transmission medium, such as a signal on a communications link. Various communications links may be used, such as the Internet, a local area network, a wide area network, or a point-to-point dial-up connection.

The relevance system may be implemented in various operating environments. The operating environment described herein is only one example of a suitable operating environment and is not intended to suggest any limitation as to the scope of use or functionality of the relevance system. Other well-known computing systems, environments, and configurations that may be suitable for use include personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The relevance system may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

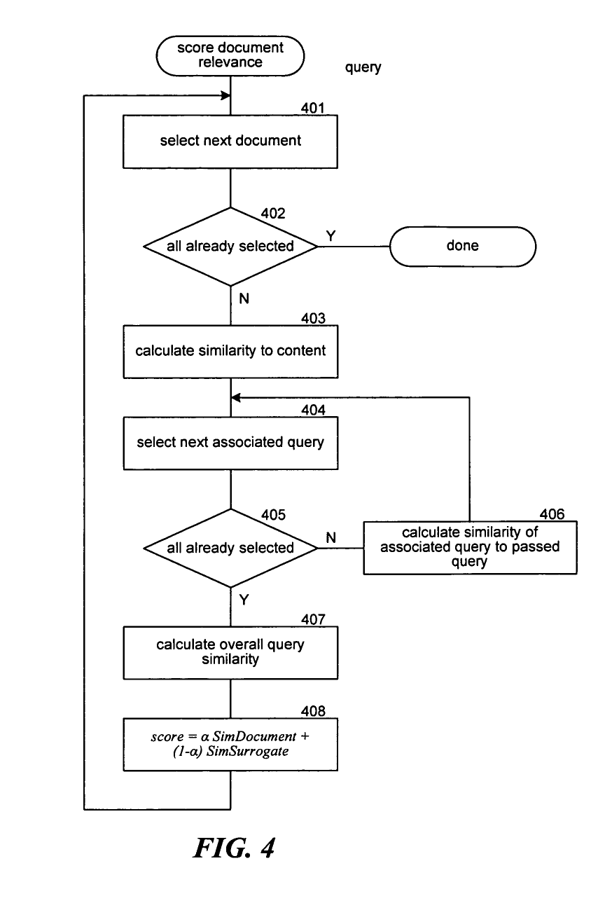

FIG. 4 is a flow diagram illustrating the processing of the score document relevance component of the relevance system in one embodiment. The component is passed a query and calculates a relevance score for each document. The component loops selecting each document and calculating its relevance. In block 401, the component selects the next document. In decision block 402, if all the documents have already been selected, then the component completes, else the component continues at block 403. In block 403, the component calculates the similarity of the query to the content of the selected document. In blocks 404-406, the component loops calculating the similarity between the query and each query associated with the selected document. In block 404, the component selects the next query associated with the selected document. In decision block 405, if all the associated queries have already been selected, then the component continues at block 407, else the component continues in block 406. In block 406, the component calculates the similarity of the query to the selected associated query and then loops to block 404 to select the next associated query. In block 407, the component calculates the overall query similarity or surrogate content similarity. In block 408, the component combines the document content similarity and the surrogate content similarity to generate an overall relevance score for the selected document and then loops to block 401 to select the next document.

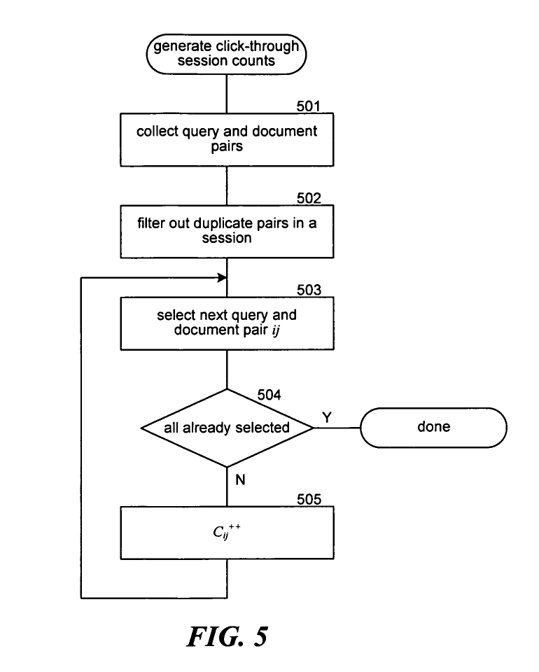

FIG. 5 is a flow diagram that illustrates the processing of the generate click-through session counts component of the relevance system in one embodiment. The component identifies selecting query and selected document pairs and counts the number of query sessions in which that selecting query results in the selected document being selected. In block 501, the component collects the selecting query and selected document pairs. In block 502, the component filters out duplicate pairs from the same session. In blocks 503-505, the component loops calculating the session counts. In block 503, the component selects the next query and document pair. In decision block 504, if all the pairs have already been selected, then the component completes, else the component continues at block 505. In block 505, the component increments the count for the selected query and document pair and then loops to block 503 to select the next query and document pair.

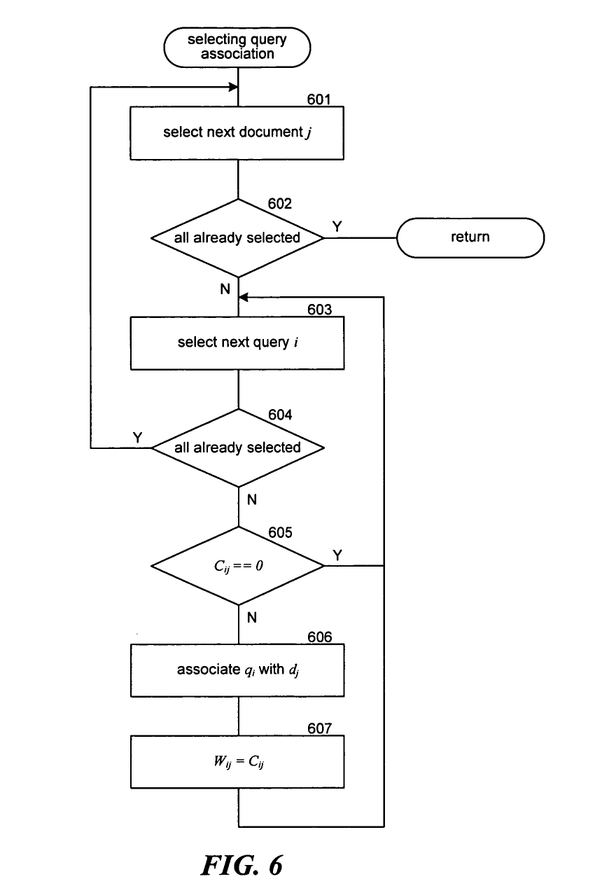

FIG. 6 is a flow diagram that illustrates the processing of the selecting query association component of the relevance system in one embodiment. The component identifies the selecting queries for each document and establishes the weight for each associated query for each document. In block 601, the component selects the next document. In decision block 602, if all the documents have already been selected, then the component returns, else the component continues at block 603. In block 603, the component selects the next selecting query for the selected document. In decision block 604, if all the selecting queries have already been selected, then the component loops to block 601 to select the next document, else the component continues at block 605. In decision block 605, if the count for the selected query and document pair is zero, the component loops to block 603 to select the next query, else the component continues at block 606. In block 606, the component associates the selected query with the selected document. In block 607, the component establishes the weight of the selected query for the selected document based on the count associated with the selected query and document pair. The component then loops to block 603 to select the next query.

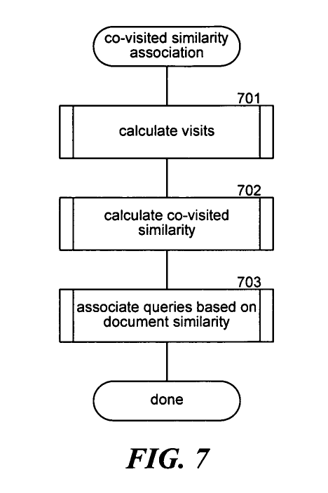

FIG. 7 is a flow diagram that illustrates the processing of the co-visited similarity association component of the relevance system in one embodiment. The component associates queries with documents based on the co-visited similarity between documents. In block 701, the component invokes the calculate visits component to calculate the number of times documents are visited and pairs of documents are co-visited. In block 702, the component invokes the calculate co-visited similarity component to calculate the co-visited similarity for pairs of documents. In block 703, the component invokes the associate queries based on document similarities component to associate queries with documents based on the co-visited similarity.

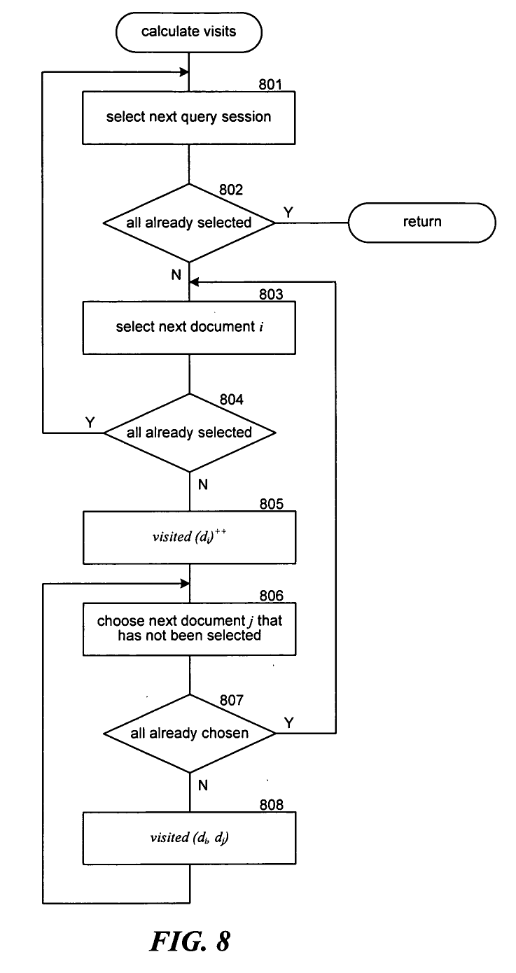

FIG. 8 is a flow diagram that illustrates the processing of the calculate visits component of the relevance system in one embodiment. The component loops selecting each query session, incrementing the visited count for each selected document of that query session, and incrementing the co-visited count for each pair of selected documents. In block 801, the component selects the next query session. In decision block 802, if all the query sessions have already been selected, the component returns, else the component continues at block 803. In block 803, the component selects the next document for the selected query session. In decision block 804, if all the documents have already been selected, then the component loops to block 801 to select the next query session, else the component continues at block 805. In block 805, the component increments the visited count for the selected document. In block 806, the component chooses the next document of the query session that has not already been selected. In decision block 807, if all the documents have already been chosen, then the component loops to block 803 to select the next document, else the component continues at block 808. In block 808, the component increments the co-visited count for the selected and chosen documents and then loops to block 806 to choose the next document.

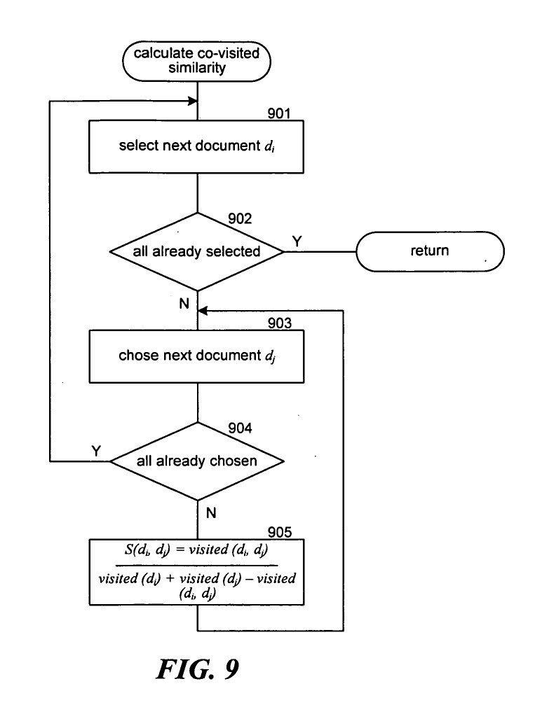

FIG. 9 is a flow diagram that illustrates the processing of the calculate co-visited similarity component of the relevance system in one embodiment. The component calculates the co-visited similarity for each pair of documents. In block 901, the component selects the next document. In decision block 902, if all the documents have already been selected, then the component returns, else the component continues at block 903. In block 903, the component chooses the next document for the selected document. In decision block 904, if all the documents have already been chosen, then the component loops to block 901 to select the next document, else the component continues at block 905. In block 905, the component calculates the similarity for the selected and chosen documents and then loops to block 903 to choose the next document.

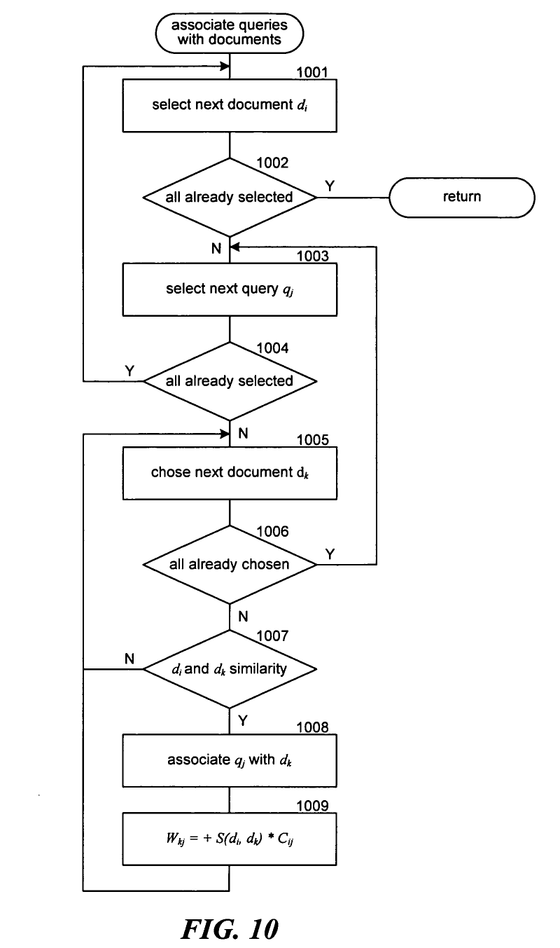

FIG. 10 is a flow diagram that illustrates the processing of the associate queries with documents component of the relevance system in one embodiment. The component loops selecting documents and associating the queries of the selected document with similar documents. In block 1001, the component selects the next document. In decision block 1002, if all the documents have already been selected, then the component returns, else the component continues at block 1003. In block 1003, the component selects the next selecting query for the selected document. In decision block 1004, if all the selecting queries have already been selected for the selected document, then the component loops to block 1001 to select the next document, else the component continues in block 1005. In blocks 1005-1009, the component loops choosing each document and associating the selected query with the chosen document if it is similar to the selected document. In block 1005, the component chooses the next document. In block 1006, if all the documents have already been chosen, then the component loops to block 1003 to select the next selecting query, else the component continues at block 1007. In decision block 1007, if the selected and chosen documents are similar, then the component continues in block 1008, else the component loops to block 1005 to choose the next document. In block 1008, the component associates the query with the chosen document. In block 1009, the component calculates the weight for the selected query for the chosen document and then loops to block 1005 to choose the next document.

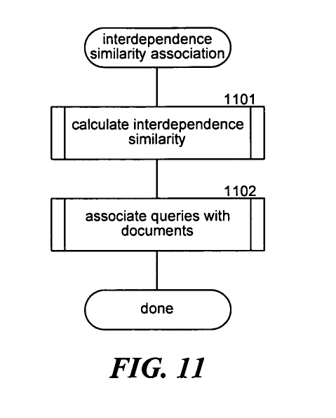

FIG. 11 is a flow diagram that illustrates the processing of the interdependence similarity association component of the relevance system in one embodiment. In block 1101, the component calculates the interdependence similarity for the documents. In block 1102, the component invokes the associate queries with documents component and then completes.

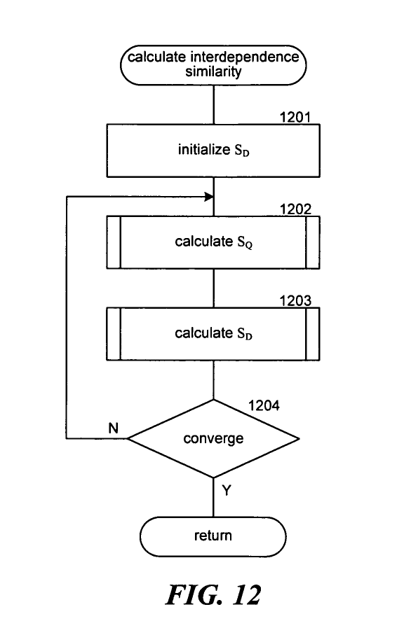

FIG. 12 is a flow diagram that illustrates the processing of the calculate interdependence similarity component of the relevance system in one embodiment. The component initializes the document similarity and then loops calculating the query similarity based on the document similarity and then the document similarity based on the query similarity until the similarities converge from one iteration to the next. In block 1201, the component initializes the document similarity for each pair of documents. In block 1202, the component invokes the calculate query similarity component. In block 1203, the component invokes the calculate document similarity component. In decision block 1204, if the similarities converge, then the component returns, else the component loops to block 1202 to perform the next iteration.

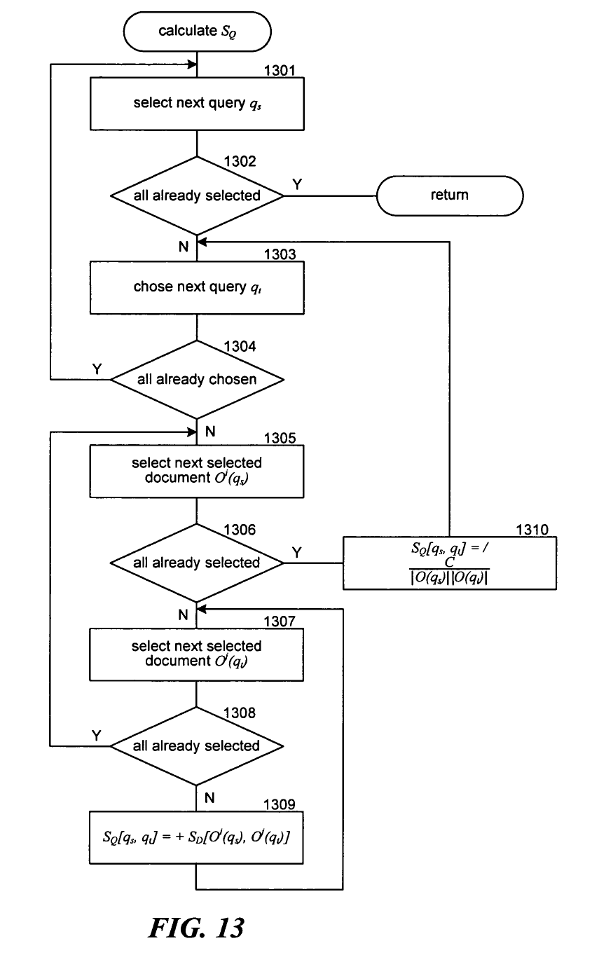

FIG. 13 is a flow diagram that illustrates the processing of the calculate query similarity component of the relevance system in one embodiment. The component loops calculating the similarity for pairs of queries. In block 1301, the component selects the next query. In decision block 1302, if all the queries have already been selected, then the component returns, else the component continues at block 1303. In block 1303, the component chooses the next query. In block 1304, if all the queries have already been chosen, then the component loops to block 1301 to select the next query, else the component continues at block 1305. In block 1305, the component selects the next document for the selected query. In decision block 1306, if all the selected documents have already been selected, then the component continues at block 1310, else the component continues at block 1307. In block 1307, the component selects the next selected document for the chosen query. In decision block 1308, if all the selected documents have already been selected, then the component loops to block 1305, else the component continues at block 1309. In block 1309, the component increases the query similarity for the selected and chosen queries based on the similarity between the selected documents and then loops to block 1307 to select the next document for the chosen query. In block 1310, the component normalizes the query similarity for the selected and chosen documents and then loops to block 1303 to choose the next query for the selected query.

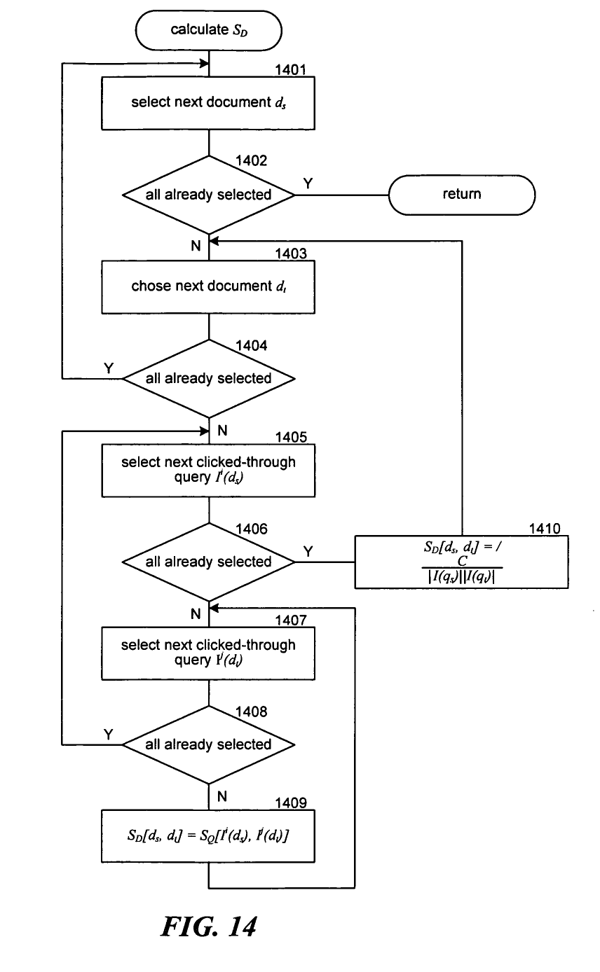

FIG. 14 is a flow diagram that illustrates the processing of the calculate document similarity component of the relevance system in one embodiment. The component calculates the document similarity in a manner analogous to the calculation of the query similarity as described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method for determining relevance of a document to a query, the method comprising:
associating queries with documents; and
calculating relevance of a document to a query based on similarity of the query to the queries paired with the document.

2. The method of claim 1 wherein the queries associated with a document are queries such that when a user submitted the query and received a query result, the user selected the document from the query result.

3. The method of claim 1 wherein the associating of queries with documents is based on analysis of click-through data.

4. The method of claim 1 including calculating a weight for queries associated with a document wherein the calculated relevance factors in the weight for a query.

5. The method of claim 1 including determining similarity between documents based on the documents based on their co-visited relationship and when a document is similar to another document, associating with the document selecting queries of the other document.

6. The method of claim 1 wherein a selecting query of a document is associated with another document based on the document and the other document being selected during the same query session.

7. The method of claim 1 including determining similarity between documents based on interdependence of the similarity of documents with the similarity of queries and when a document is similar to another document, associating with the document selecting queries of the other document.

8. The method of claim 1 wherein a selecting query of a document is associated with another document when the document and the other document are similar.

9. The method of claim 8 wherein documents are similar based on the similarity of their selecting queries.

10. The method of claim 9 wherein queries are similar based on the similarity of their selected documents.

11. A method for determining similarity of documents, the method comprising:
providing pairs of a selecting query and a selected document; and
calculating a similarity between documents from the provided pairs based on interdependence of similarity of documents and similarity of queries.

12. The method of claim 11 wherein the provided pairs are derived from analysis of click-through data.

13. The method of claim 11 wherein the similarity of documents is based on the similarity of their selecting queries and the similarity of queries is based on the similarity of their selected documents.

14. The method of claim 11 wherein similarity is calculated using the following equations:
$${S}_{Q} [ {q}_{s} , {q}_{t} ] = \frac{C}{\vert O ( {q}_{s} ) \vert \vert O ( {q}_{t} ) \vert} {\sum }_{i = 1}^{\vert O ( {q}_{s} ) \vert} {\sum }_{j = 1}^{\vert O ( {q}_{t} ) \vert} {S}_{D} [ {O}^{i} ( {q}_{s} ) , {O}^{j} ( {q}_{t} ) ]$$
where C is a decay factor, O(q) is the set of the selected documents of q, and Oⁱ(q) represents the ith document in the set, and
$${S}_{D} [ {d}_{s} , {d}_{t} ] = \frac{C}{\vert I ( {d}_{s} ) \vert \vert I ( {d}_{t} ) \vert} {\sum }_{i = 1}^{\vert I ( {d}_{s} ) \vert} {\sum }_{j = 1}^{\vert I ( {d}_{t} ) \vert} {S}_{Q} [ {I}^{i} ( {d}_{s} ) , {I}^{j} ( {d}_{t} ) ]$$
where C is a decay factor, I(d) is the set of the selecting queries of d, and Iⁱ(d) represents the ith query in the set.

15. The method of claim 11 including associating with a document the selecting queries of a similar document.

16. The method of claim 15 including calculating relevance of a document to a query based on the similarity of the associated queries to the query.

17. The method of claim 16 wherein each query associated with a document has a weight indicating how these similarities are to be weighted when calculating relevance.

18. A computer system for generating a query result, comprising:
a component that identifies queries and documents selected from the result of the queries;
a component that associates queries with a document based on analysis of the identified queries and documents;
a component that receives a query and calculates relevance of the received query to a document based on the queries associated with the document; and
a component that uses the calculated relevance in providing a result of the query.

19. The computer system of claim 18 wherein a selecting query of a document is associated with another document when the document and the other document are co-visited.

20. The computer system of claim 18 wherein a selecting query of a document is associated with another document when the document and the other document are similar and wherein the similarity of documents is calculated based on interdependence of similarity of documents and similarity of queries.
